(19) United States
(12) Patent Application Publication
(10) Pub. No.: US 2013/0073518 A1
(43) Pub. Date: Mar. 21, 2013

(54) INTEGRATED TRANSACTIONAL AND DATA WAREHOUSE BUSINESS INTELLIGENCE ANALYSIS SOLUTION

(71) Applicants: Manish SRIVASTAVA, Cary, NC (US); German BERTOT, Foster City, CA (US); Yu Lung NG, Kowloon (HK); Suman GUHA, Fremont, CA (US); Lee Hian QUEK, Foster City, CA (US); Jeff GLANVILLE, Menlo Park, CA (US)

(72) Inventors: Manish SRIVASTAVA, Cary, NC (US); German BERTOT, Foster City, CA (US); Yu Lung NG, Kowloon (HK); Suman GUHA, Fremont, CA (US); Lee Hian QUEK, Foster City, CA (US); Jeff GLANVILLE, Menlo Park, CA (US)

(21) Appl. No.: 13/237,865

(22) Filed: Sep. 20, 2011

(51) Int. Cl. G06F 17/30

(52) U.S. Cl. 707/607; 707/E17.005

(57) ABSTRACT

A system, computer-implemented method, and computer program product for performing integrated transactional and data warehouse business intelligence analysis using a correlated report constructed from data correlations between current transactional data and historical data from a data warehouse. The method commences by retrieving a transactional data record from an online transactional processing (OLTP) system, the transactional data record comprising at least one OLTP business intelligence value of a particular business intelligence attribute, then receiving from a storage system, results of a query to a data warehouse, the results comprising a historical business intelligence value of the same business intelligence attribute. Modules within the system (e.g., a business intelligence application) perform processing to combine the OLTP business intelligence value with the historical business intelligence value to form a correlated report and transmit the correlated report for displaying on a single surface.

### FIELD

The disclosure relates to the field of data management in an electronic business intelligence system and more particularly to systems for integration of historical data with online transactional data.

### COPYRIGHT NOTICE

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### BACKGROUND

In a business setting, and in order to facilitate accurate business decision making, it is often desirable to consider more information than it is to consider less information when formulating a business decision. Increasing the amount of information to be considered, however, often increases the complexity and introduces difficulties into the decision making process. In the current “information age”, and with the ease of computer-aided data retrieval, the amount of information that could be considered in the making of business decisions can be voluminous, further exacerbating the problem. It is desirable to optimize information presentation in such a way as to be readily understood by decision makers.

One legacy approach to presenting information to a decision maker is to present raw data. This approach is generally not preferred by decision makers because a large amount of time is expended by the decision maker in assimilating and understanding the data in order to derive information for decision-making. Furthermore, the decision maker may not have the training or experience to correctly analyze the information. Another frequently used legacy approach for presenting information is to organize the material for presentation using graphs and charts compiled from vast information. Many different forms of graphs and charts have typically been used, depending on the type of information to be presented. This approach can work well for decision maker assimilation when the information is the type that is easily organized in graph or chart form. Yet, information presented in graphs and charts can be difficult for the decision maker to assimilate, particularly when information relevant to a particular current event (often in a first report) must be compared with information relevant to other historical events (often in a separate, second report). And, often, any trends in the data are only perceivable when trend charts are laboriously compiled.

Still further exacerbating the problems with presenting vast information (e.g., business intelligence) is that information pertaining to business intelligence vis-à-vis the current state of affairs (e.g., current events) are often stored in one system (e.g., in a transaction processing system), while information pertaining to business intelligence vis-à-vis historical events are often stored in a different system (e.g., in a data warehouse). As an example, historical balance sheets might be stored in a data warehouse, while a current period income statement might be stored in a transaction processing system.

What is needed are techniques to address the deficiencies of the legacy solutions and, more specifically, to address the presentation of business intelligence data using techniques to integrate transactional data together with data warehouse data into a single correlated report (e.g., a procurement dashboard) for display on a single surface. Moreover, techniques are needed to present on a single surface, a user interface to facilitate the “drill down” (e.g., presenting successively more detail) from a summary-level of presentation down through transaction-level of presentation in a seamless manner.

### SUMMARY

When there is a need to compare up-to-the-minute business intelligence (BI) information from numerous events or transactions, there is often an additional requirement to look at a history of such events or transactions. And, when the statistics derived from the historical events or of the historical transactions are relevant or comparable in some way to up-to-the-minute business intelligence, then it is felicitous to provide a single combined, correlated report showing the historical data presented using the same type and format as is used for presenting the up-to-the-minute data. However, especially since up-to-the-minute business intelligence and historical data are stored in different systems, various techniques are needed to retrieve and process historical data and transactional data and to format in such a way that the two types of data can be combined together in the same report, and displayed on one screen using human-comfortable formats (such as traditional graphs and charts).

The disclosure herein presents a system and method for performing integrated transactional and data warehouse business intelligence analysis using a correlated report constructed from data correlations between current transactional data and historical data from a data warehouse. The method commences by retrieving a transactional data record from an online transactional processing (OLTP) system, the transactional data record comprising at least one OLTP business intelligence value of a particular business intelligence attribute, then receiving results of a query to a data warehouse, the results comprising a historical business intelligence value of the same business intelligence attribute. Modules within the system (e.g., a business intelligence application) perform processing to combine the OLTP business intelligence value with the historical business intelligence value to form a correlated report and transmit the correlated report for displaying on a single surface.

### BRIEF DESCRIPTION OF THE DRAWINGS

FIG. 1 illustrates an environment for implementing an integrated transactional and data warehouse business intelligence analysis solution, according to some embodiments.

FIG. 2A illustrates a use model for implementing integrated transactional and data warehouse business intelligence analysis solutions using multiple applications, according to some embodiments.

FIG. 2B illustrates a use model for implementing an integrated transactional and data warehouse business intelligence analysis solution using a single business intelligence application, according to some embodiments.

FIG. 3 illustrates a flow for using an integrated transactional and data warehouse business intelligence analysis solution using a single business intelligence application, according to some embodiments.

FIG. 4 illustrates an exemplary correlated report display for an integrated transactional and data warehouse business intelligence analysis solution using a single business intelligence application, according to some embodiments.

FIG. 5 illustrates an exemplary correlated report display for an integrated transactional and data warehouse business intelligence analysis solution using a single business intelligence application for displaying a second set of business intelligence values, according to some embodiments.

FIG. 6 depicts a block diagram of a system for performing integrated transactional and data warehouse business intelligence analysis, according to some embodiments.

FIG. 7 illustrates a computer system on which an embodiment of the claims can be implemented.

### DETAILED DESCRIPTION

Embodiments of the present disclosure are directed to an improved approach for implementing integrated transactional and data warehouse business intelligence analysis solutions.

### Introduction

When there is a need to compare up-to-the-minute business intelligence (BI) information from numerous events or transactions, there is often an additional requirement to look at a history of such events or transactions. And, when the statistics derived from the historical events or from the historical transactions are relevant or comparable in some way to up-to-the-minute business intelligence, then it is felicitous to provide a single combined, correlated report showing the historical data presented using the same type and format as is used for presenting the up-to-the-minute data. However, especially since up-to-the-minute business intelligence and historical data are stored in different systems, various techniques are needed to retrieve and process historical data and transactional data and to format in such a way that the two types of data can be combined together in the same report, and displayed on one screen using human-comfortable formats (such as traditional graphs and charts). Techniques are provided herein to present on a single surface, a user interface to facilitate the “drill down” (e.g., presenting successively more detail) from a summary-level of presentation down through transaction-level of presentation in a seamless manner.

Moreover, as the members of an organization become increasingly mobile (e.g., field sales personnel and others in a sales organizations), it becomes problematic to deliver such vast amounts of information into the hands of the individuals that may need to act on the information. Therefore, it is desirable for everyone in an organization, from the sales and support personnel to the chief executive officer, to be able to take a quick look at significant transactional data, make an efficient evaluation, and determine the best decisions (e.g., to maximize potential business prospects, or to pursue or the most serious support problems to fix, etc.).

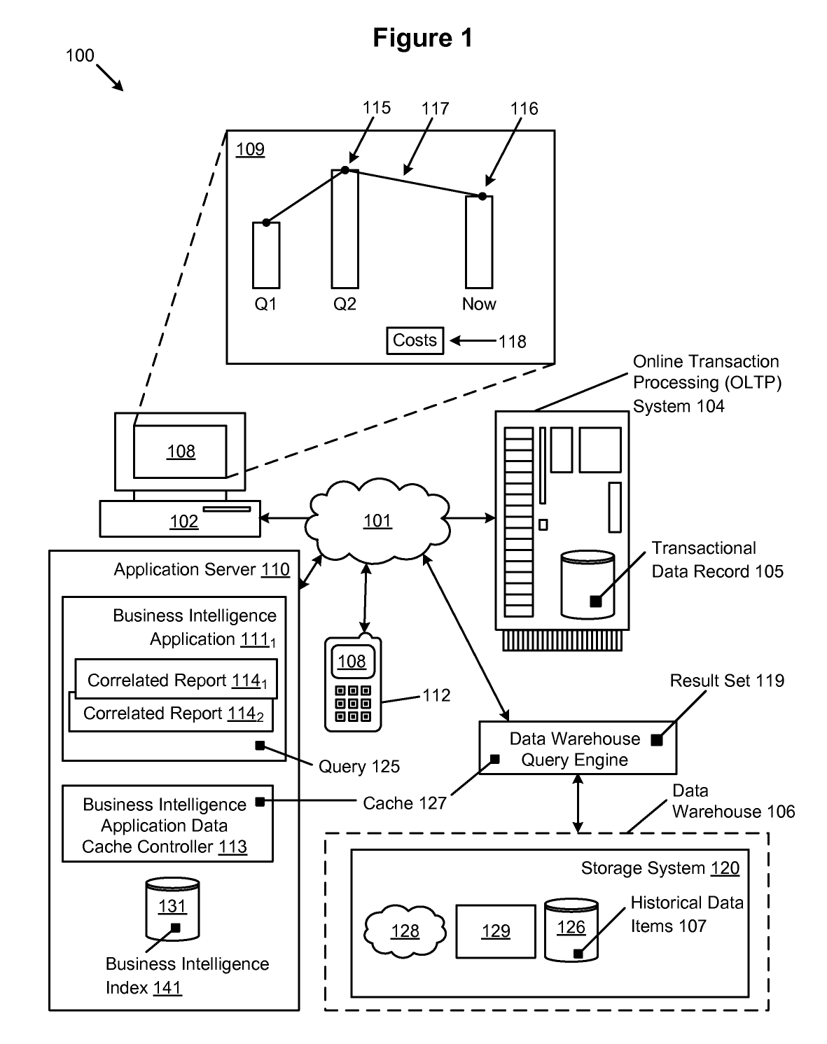

FIG. 1 illustrates an environment 100 for implementing an integrated transactional and data warehouse business intelligence analysis solution, according to some embodiments. In such an environment, business people desire that business intelligence reports include up-to-the-minute transaction information, as well as include somewhat older data (e.g., such as data as of the end of the previous day or previous week or previous month, etc.). In some cases, analysis of data, especially analysis of vast amounts of historical data, can become computationally intensive. In some environments, analysis of vast amounts of historical data are computed using data from a business intelligence data warehouse. In one possible scenario, data from a business intelligence data warehouse is periodically extracted, analyzed, summarized in a pre-computed summaries and stored in pre-computed forms for later use. In some other cases, the pre-computed data is stored in a cache for subsequent (and possibly repeated) quick access to such pre-computed data.

In contrast to the aforementioned techniques for accessing data from a business intelligence data warehouse in the form of recent transactions (e.g., transactions that as of that point in time have not yet been stored in a BI data warehouse) can be retrieved via an online transaction processing (OLTP) system. In legacy environments, users had to navigate separately through the applications of separate systems, and users were forced to interpret multiple BI reports, namely reports based on data from a BI data warehouse reports based on data from OLTP transaction data.

As shown, environment 100 includes an online transaction processing system 104, a data warehouse 106, a network 101 (e.g., a LAN or an intranet or the Internet), and several user terminals (e.g., user terminal 102 and mobile device 112). Also shown is an application server 110, which application server is configured to generate business intelligence in the form of one or more correlated reports 114 (e.g., correlated report 114₁, correlated report 114₂, as depicted), which correlated reports are stored in volatile or non-volatile storage, and can be rendered (e.g., on a display surface 108) as a correlated report display 109.

According to exemplary embodiments, the rendering of a correlated report on the single surface includes display of business intelligence that presents a correlated report display 109 in conjunction with up-to-the-minute transaction information, and moreover relates the historical data to the up-to-the-minute transaction information, using a graphical display screen device such as a trend line 117.

In preparing the aforementioned correlated report 114, one or more OLTP systems serve for retrieving transactional data records 105, the transactional data comprising one or more instances of an OLTP business intelligence value 116 pertaining to a particular business intelligence attribute 118 (e.g., quarterly costs, etc.). Contemporaneously, other systems serve for retrieving historical data via a query 125 to a data warehouse 106 (e.g., via storage system 120), the historical data comprising one or more instances of a historical business intelligence value 115 of a business intelligence attribute 118 (e.g., quarterly costs, etc.). In exemplary embodiments, execution of such a query 125 returns a result set 119.

Having received the both the historical data and the up-to-the-minute transaction information, the system commences further processing (e.g., in an application server 110) one or more business intelligence applications 111. For example, the business intelligence application prepares a correlated report by combining one or more “Cost” data items from the historical data with one or more “Cost” data items from the up-to-the-minute transaction information and then displaying the correlated report 114 on a single surface 108.

For addressing the needs of business people to analyze historical data together with current data in the same format and on the same display using comfortable formats (such as traditional graphs and charts), an application server and/or a business intelligence application 111 can perform reformatting of the data in the correlated report to display specific up-to-the minute transactional data juxtaposed with historical data, and can include trend lines to relate the values of the business intelligence attribute.

Moreover, for addressing the need by sales people (who are very frequently “on the road”) an application server can be configured to reformat correlated reports so as to display conveniently on a screen (e.g., single surface 108) of a mobile device 112. In fact, an application server can perform as a web server and serve web pages or correlated reports to a mobile device by transmitting the reformatted correlated report to the mobile device.

As previously mentioned, in certain cases, pre-computed data is stored in a cache for subsequent (and possibly repeated) quick access to such pre-computed data. Such caching can be extended to include any variety or combination of data. For example, an application server 110 can be configured to implement intermediate storage comprising a cache 127 (e.g., using a business intelligence application data cache controller 113), and such a cache can be used to store any sorts of data, including any portions of the aforementioned pre-computed data, and/or any reports or portions of reports. In fact, and as shown, business intelligence application data cache controller 113 serves to recognize data (e.g., transactional data records 105, historical data items 107, pre-computed summaries, pre-computed data, and/or any reports or portions of reports, application server data, etc.) as data that has a likelihood of repeated retrieval (e.g., a daily report for viewing by multiple field sales people), and stores such data in non-volatile application storage 131 for such repeated retrieval. In some cases there is a sufficient volume of data that has a likelihood of repeated retrieval that an application server 110 manages a business intelligence index 141 for fast retrieval.

In another embodiment involving caching, in some cases data retrieved via an online transaction processing system 104 the data retrieved may be rapidly-changing data. In some situations a user might indeed want a report that includes up-to-the-minute data (e.g., while watching updated bids in an auction), yet in other situations the user might want a report that includes moderately recent transaction data, especially transaction data that has not yet been (as of that point in time) stored in a BI data warehouse (e.g., the results of yesterday's auctions). In the latter case, a report that includes transaction data can be compiled using a cache, where the cache is used to store any one or more transactional data records data that have not yet been stored in the storage system of a BI data warehouse.

In addition to uses of a cache or caches for the purposes heretofore described, the cache can also be used for managing latency of access to persistent storage. For example, persistent storage can be formed by descriptions stored within files (e.g., in a file system found on storage device 126), or within relations (e.g., within a relational database 129), or can be formed of data retrieved via a network or cloud 128.

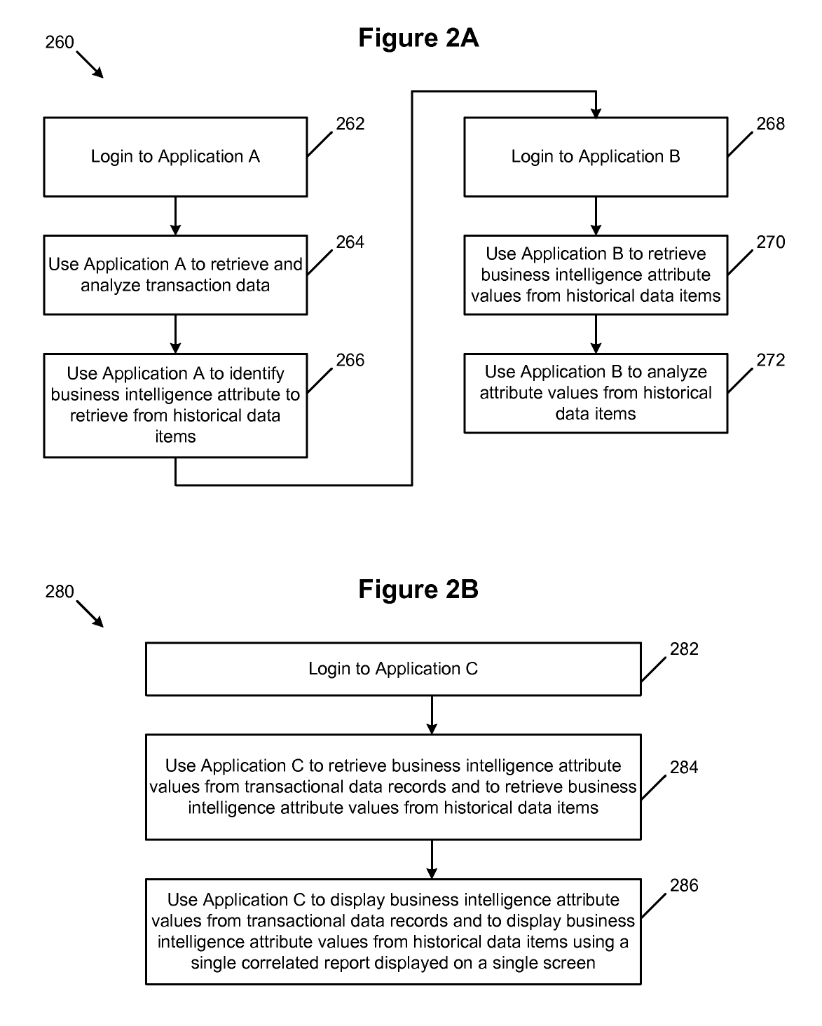

FIG. 2A illustrates use a model for implementing integrated transactional and data warehouse business intelligence analysis solutions using multiple applications. In the use model 260 as shown, a user logs into a first application such as “Application A” (see operation 262), and uses Application A to retrieve and analyze transaction data such as data that is from an online transaction processing system (see operation 264), then further uses Application A to identify the needed business intelligence attribute 118 (e.g., “Costs by Quarter in Previous Year”) that can be retrieved from historical data (see operation 266). The user proceeds to log into “Application B” (see operation 268) and use Application B to retrieve data as pertaining to the identified business intelligence attribute from the historical data items (see operation 270), and further to use Application B to analyze the business intelligence attribute values as retrieved from the historical data items (see operation 272). Having collected (e.g., at a user terminal 102, or using an application server 110), the business intelligence attribute values from the transactional data records as well as having collected the business intelligence attribute values from the historical data items, then a business intelligence application can prepare a single correlated report and display on single surface 108.

The use model 260 offers users several possibilities for different situations, as shown in Table 1.

TABLE 1
Use Models Applicable in Certain Situations

| Use Model | Situation |
|---|---|
| Rely on data warehouse | Serves in situations where only historical |
| based BI reports for all | data is needed. Some cases may demand |
| requirements | higher accuracy and/or more real-time BI to |
| | accomplish certain reports and metrics that |
| | need online, real-time or near-real-time |
| | information (e.g., from OLTP systems) |
| Rely on transactional BI | Serves in situations where only OLTP |
| reports for all requirements | data is needed. However, certain reports may |
| | demand high computational requirements, |
| | which computations might be performed |
| | offline in a data warehouse |

An alternative use case allows the user to get all required BI information from a single BI application without compromising on accuracy or performance.

FIG. 2B illustrates a use model for implementing integrated transactional and data warehouse business intelligence analysis solutions using a single BI application. In the use model 280 as shown, the user logs into an application such as “Application C” (see operation 282), and uses Application C to retrieve business intelligence attribute values from transactional data records and to retrieve business intelligence attribute values from historical data items (see operation 284). Now, given that Application C has retrieved both transactional data records and historical data items, the user proceeds to use Application C to display business intelligence attribute values from transactional data records and to display business intelligence attribute values from historical data items using a single correlated report displayed on a single screen (see operation 286), thus facilitating analysis.

Embodiments implemented corresponding to use model 280 serve to provide a single correlated report (e.g., a “procurement dashboard”) that combines business intelligence attribute values from both data warehouse and OLTP transaction data. In some embodiments, a single correlated report is presented in a unified user interface. In some cases the single correlated report is composited into separate proximal regions of the same procurement dashboard within an enterprise business intelligence platform.

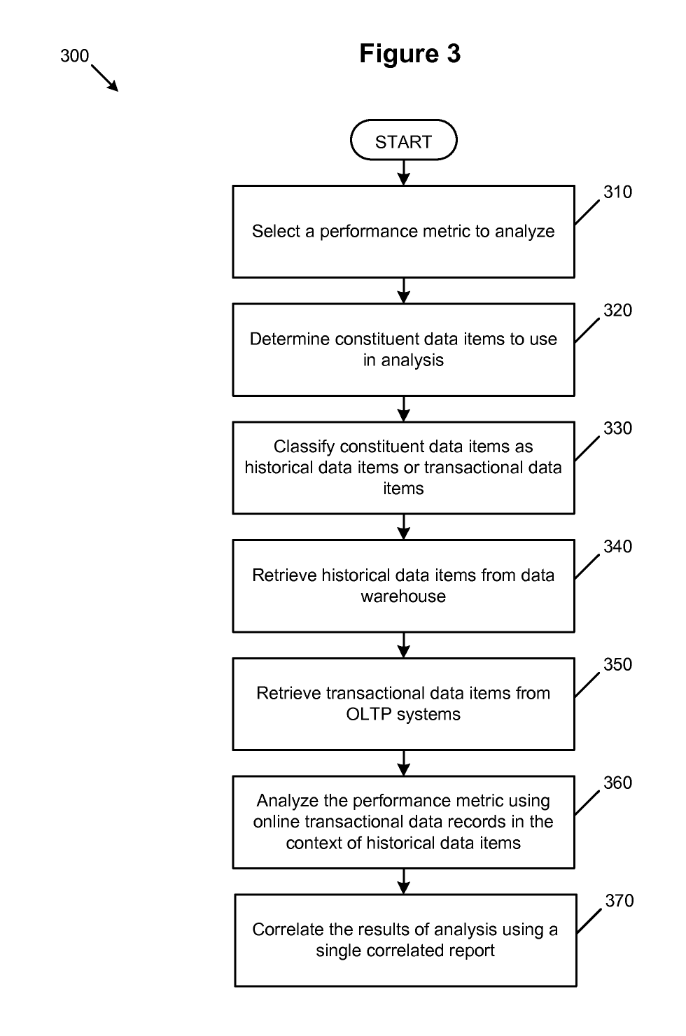

FIG. 3 illustrates a flow for using integrated transactional and data warehouse business intelligence analysis solution using a single business intelligence application. The flow 300 commences by selecting a performance metric (e.g., “Sales”) to analyze (see operation 310), and proceeds to determine constituent data items needed to use in the analysis (see operation 320). In exemplary cases, the data items needed to use in the analysis include both transactional data records, and historical data items. In some cases the time periods over which the performance metric is to be analyzed may be such that retrieved data corresponding to a first time period segment is retrieved entirely from OLTP transactional data records. Similarly, In some cases the time periods over which the performance metric is to be analyzed may be such that retrieved data corresponding to a second time period segment is retrieved entirely from historical data items. Or, in some cases the first time period and the second time period overlap to some extent. Techniques within operation 330 serve to consider the time periods (e.g., the first time period and the second time period) and consider the correlated nature of constituent data; namely considering the availability of the constituent data as to be retrieved from an OLTP system, or to be retrieved from a data warehouse, and to determine an appropriate graph or chart for use in the correlated report and display thereof.

As mentioned above, there are situations that have high computational demands. In one embodiment, computations might be performed one platform (e.g., by an application server 110), or another platform (e.g., as might be performed in a batch operation in a data warehouse). The techniques used within operation 330 serve to determine the platform. The determination can depend on many factors, including the empirical measurements of the computational intensity of the needed computations, and the scheduling intervals involved in moving OLTP data to a data warehouse.

Based on the results of the operation 330, the historical data items, which might include precalculated and/or cached data, can be retrieved from a data warehouse (see operation 340), and/or the transactional data records, which might include precalculated and/or cached data can be retrieved from a OLTP system (see operation 350). Having the needed correlated then, operation 360 serves to analyze the performance metric using online transactional data records in the context of the historical data items. Operation 370 then serves to correlate the results of analysis using a single report.

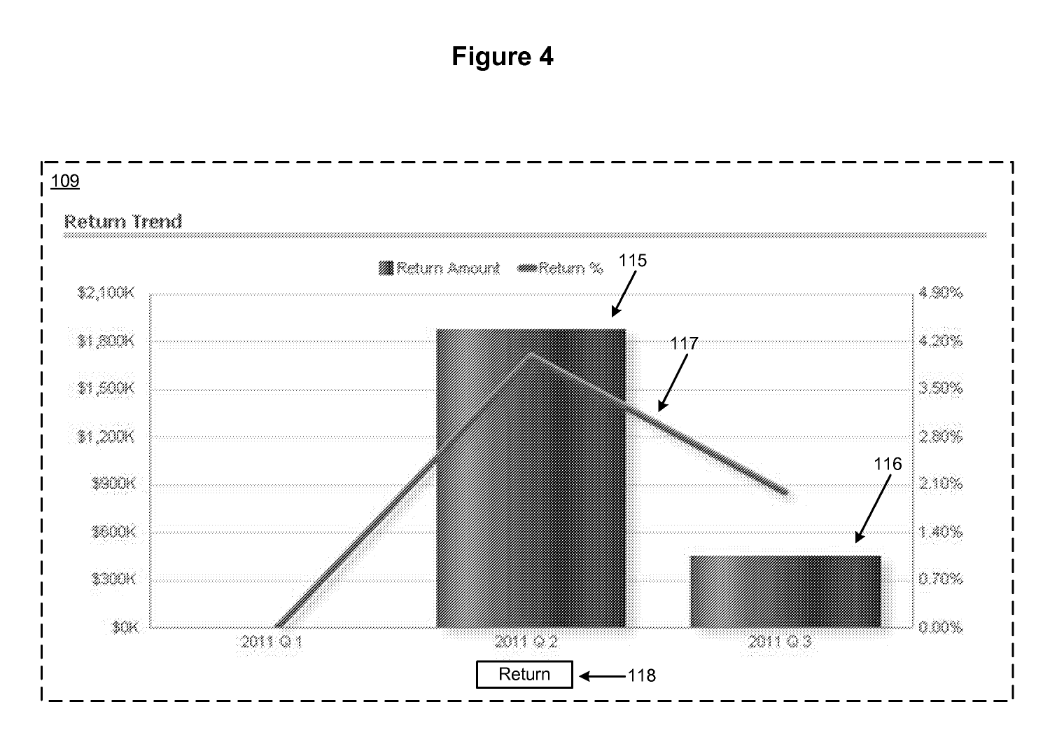

FIG. 4 illustrates an exemplary correlated report display for an integrated transactional and data warehouse business intelligence analysis solution using a single business intelligence application. As shown, the correlated report display 109 depicts a bar graph to show the correlated combination of an OLTP business intelligence value 116 with a historical business intelligence value 115. Strictly as an example, the report shows a particular business intelligence attribute 118 (e.g., “Return”), and the “Return” values are depicted in the bars of the bar graph, as well as in a trend line 117, and further the “Return” values are depicted a dollar amounts labeled on the left (abscissa) axis. The report is formatted for displaying on a single surface.

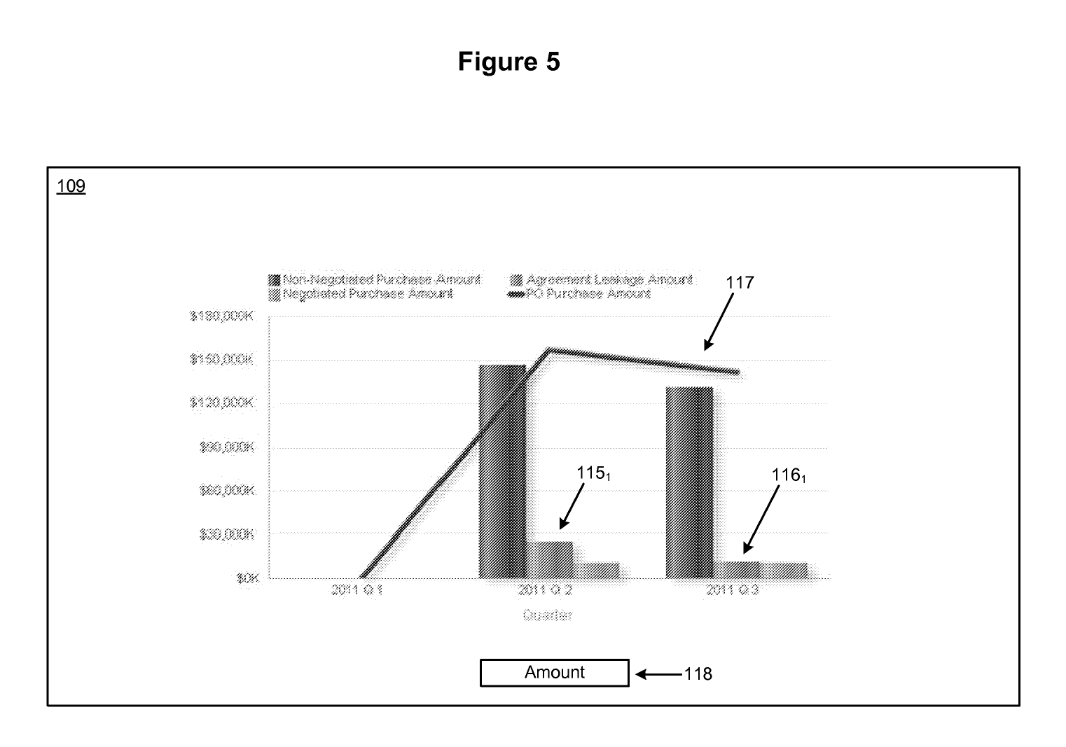

FIG. 5 illustrates an exemplary correlated report display for an integrated transactional and data warehouse business intelligence analysis solution using a single business intelligence application for displaying a second set of business intelligence values, according to some embodiments. As shown, the correlated report display 109 depicts a bar graph to show the correlated combination of a plurality of OLTP business intelligence values 116₁ with a plurality of historical business intelligence values 115₁. Strictly as an example, the report shows a particular business intelligence attribute 118 (e.g., “Amount”), and the “Amount” values are depicted in the bars of the bar graph, as well as in a trend line 117, and further the “Amount” values are depicted a dollar amounts labeled on the left (abscissa) axis. The report is formatted for displaying on a single surface.

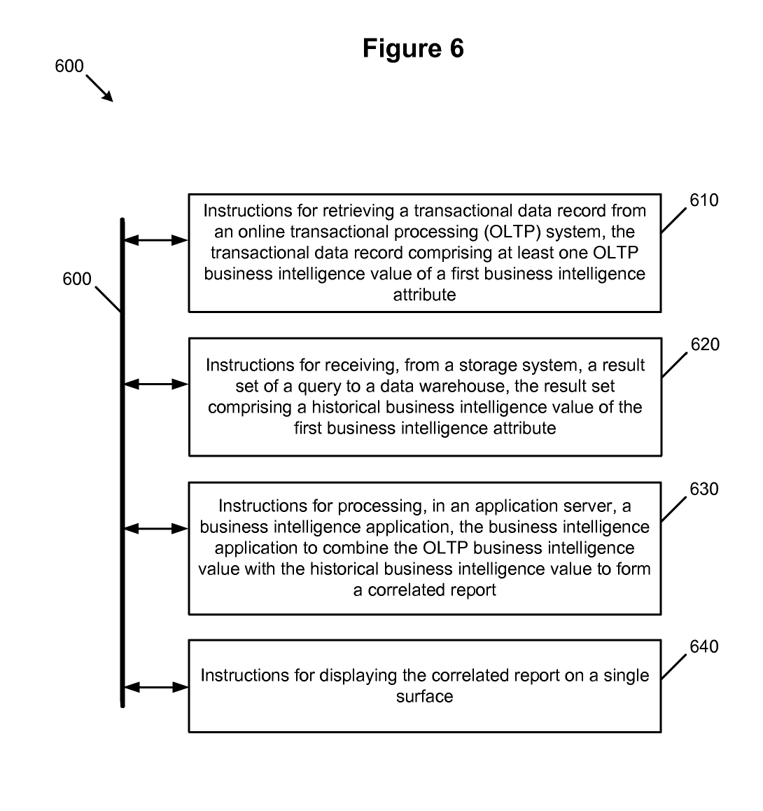

FIG. 6 illustrates a block diagram of a system for performing integrated transactional and data warehouse business intelligence analysis. As an option, the present system 600 may be implemented in the context of the architecture and functionality of the embodiments described herein. Of course, however, the system 600 or any operation therein may be carried out in any desired environment. As shown, system 600 comprises a plurality of modules, a module or collection of modules comprising at least one processor and a memory, the module or collection of modules connected to a communication link 605, and any module can communicate with other modules over communication link 605. The modules of the system can, individually or in combination, perform method steps within system 600. Any method steps performed within system 600 may be performed in any order unless as may be specified in the claims. As shown, system 600 implements a method for performing integrated transactional and data warehouse business intelligence analysis, the system 600 comprising modules, a given module having program code instructions in memory for: retrieving a transactional data record from an online transactional processing (OLTP) system, the transactional data record comprising at least one OLTP business intelligence value of a first business intelligence attribute (see module 610); receiving, from a storage system, a result set of a query to a data warehouse, the result set comprising a historical business intelligence value of the first business intelligence attribute (see module 620); processing, in an application server, a business intelligence application, the business intelligence application to combine the OLTP business intelligence value with the historical business intelligence value to form a correlated report (see module 630); and displaying the correlated report on a single surface (see module 640).

system Architecture Overview

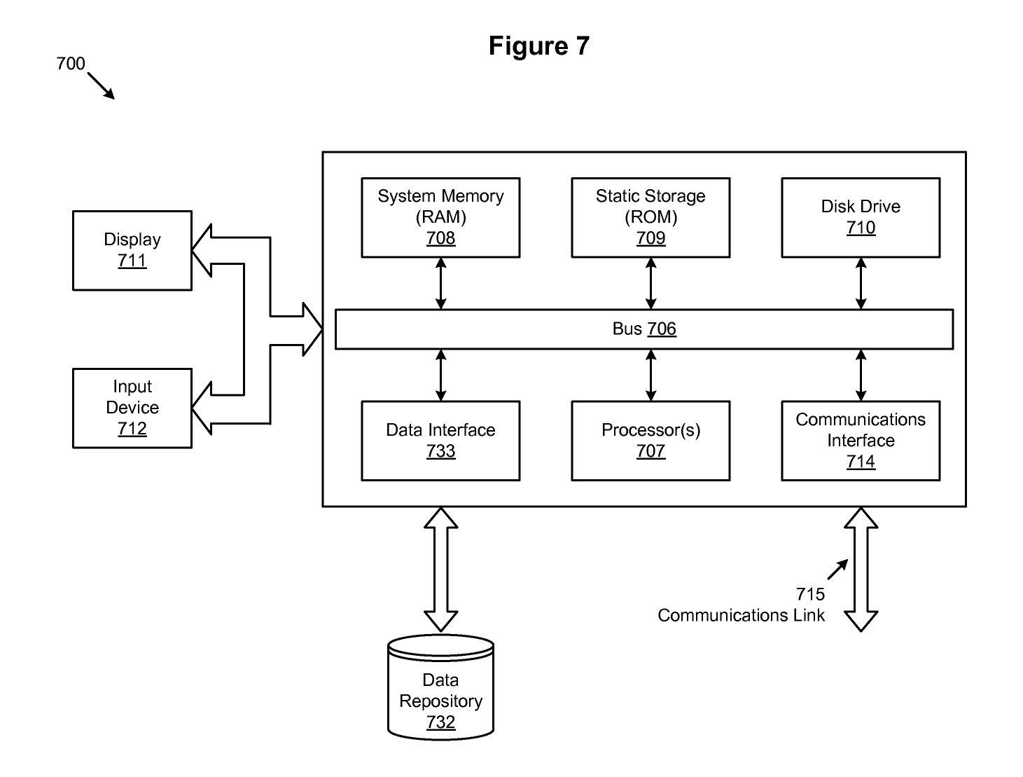

FIG. 7 depicts a block diagram of an instance of a computer system 700 suitable for implementing an embodiment of the present disclosure. Computer system 700 includes a bus 706 or other communication mechanism for communicating information, which interconnects subsystems and devices, such as a processor 707, a system memory 708 (e.g., RAM), a static storage device 709 (e.g., ROM), a disk drive 710 (e.g., magnetic or optical), a data interface 733, a communications interface 714 (e.g., modem or Ethernet card), a display 711 (e.g., CRT or LCD), input devices 712 (e.g., keyboard, cursor control), and an external data repository 732.

According to one embodiment of the disclosure, computer system 700 performs specific operations by processor 707 executing one or more sequences of one or more instructions contained in system memory 708. Such instructions may be read into system memory 708 from another computer readable/usable medium, such as a static storage device 709 or a disk drive 710. In alternative embodiments, hard-wired circuitry may be used in place of or in combination with software instructions to implement the disclosure. Thus, embodiments of the disclosure are not limited to any specific combination of hardware circuitry and/or software. In one embodiment, the term “logic” shall mean any combination of software or hardware that is used to implement all or part of the disclosure.

The term “computer readable medium” or “computer usable medium” as used herein refers to any medium that participates in providing instructions to processor 707 for execution. Such a medium may take many forms, including but not limited to, non-volatile media and volatile media. Non-volatile media includes, for example, optical or magnetic disks, such as disk drive 710. Volatile media includes dynamic memory, such as system memory 708.

Common forms of computer readable media includes, for example, floppy disk, flexible disk, hard disk, magnetic tape, or any other magnetic medium; CD-ROM or any other optical medium; punch cards, paper tape, or any other physical medium with patterns of holes; RAM, PROM, EPROM, FLASH-EPROM, or any other memory chip or cartridge, or any other non-transitory medium from which a computer can read data.

In an embodiment of the disclosure, execution of the sequences of instructions to practice the disclosure is performed by a single instance of computer system 700. According to other embodiments of the disclosure, two or more instances of computer systems 700 coupled by a communication link 715 (e.g., LAN, PTSN, or wireless network) may perform the sequence of instructions required to practice the disclosure in coordination with one another.

Computer system 700 may transmit and receive messages, data, and instructions, including program, i.e., application code, through communication link 715 and communications interface 714. Received program code may be executed by processor 707 as it is received, and/or stored in disk drive 710 or other non-volatile storage for later execution.

In the foregoing specification, the disclosure has been described with reference to specific embodiments thereof. It will, however, be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are, accordingly, to be regarded in an illustrative rather than restrictive sense.

What is claimed is:

1. A computer-implemented method for performing integrated transactional and data warehouse business intelligence analysis, the method comprising:
retrieving a transactional data record from an online transactional processing (OLTP) system, the transactional data record comprising at least one OLTP business intelligence value of a first business intelligence attribute;
receiving, from a storage system, a result set of a query to a data warehouse, the result set comprising a historical business intelligence value of the first business intelligence attribute;
processing, in an application server, a business intelligence application, the business intelligence application to combine the OLTP business intelligence value with the historical business intelligence value to form a correlated report; and
displaying the correlated report on a single surface.

2. The method of claim 1, further comprising:
reformatting the correlated report to display at least one trend line, the trend line comprising at least one point being the OLTP business intelligence value, and at least one point being the historical business intelligence value.

3. The method of claim 1, further comprising:
reformatting the correlated report to display on a mobile device.

4. The method of claim 3, further comprising:
transmitting the reformatted correlated report to the mobile device.

5. The method of claim 1, further comprising:
caching the result set in a cache; and
using the cache to access at least one of, the OLTP business intelligence value, and the historical business intelligence value.

6. The method of claim 1, wherein receiving from a storage system comprises receiving from at least one of, a relational database, a cloud, and a storage device.

7. The method of claim 1, further comprising:
processing, in an application server, a business intelligence application, the business intelligence application to combine a second OLTP business intelligence value with a second historical business intelligence value to form a correlated report.

8. A computer system for performing integrated transactional and data warehouse business intelligence analysis, the computer system comprising:
a computer processor to execute a set of program code instructions; and
a memory to hold the program code instructions, in which the program code instructions comprises program code,
to perform retrieving a transactional data record from an online transactional processing (OLTP) system, the transactional data record comprising at least one OLTP business intelligence value of a first business intelligence attribute;
to perform receiving, from a storage system, a result set of a query to a data warehouse, the result set comprising a historical business intelligence value of the first business intelligence attribute;
to perform processing, in an application server, a business intelligence application, the business intelligence application to combine the OLTP business intelligence value with the historical business intelligence value to form a correlated report; and
to perform displaying the correlated report on a single surface.

9. The computer system of claim 8, further comprising:
to perform reformatting the correlated report to display at least one trend line, the trend line comprising at least one point being the OLTP business intelligence value, and at least one point being the historical business intelligence value.

10. The computer system of claim 8, further comprising program code:
to perform reformatting the correlated report to display on a mobile device.

11. The computer system of claim 10, further comprising program code:
to perform transmitting the reformatted correlated report to the mobile device.

12. The computer system of claim 8, further comprising program code:
to perform caching the result set in a cache; and
to use the cache to access at least one of, the OLTP business intelligence value, and the historical business intelligence value.

13. The computer system of claim 8, wherein receiving from a storage system comprises receiving from at least one of, a relational database, a cloud, and a storage device.

14. The computer system of claim 8, further comprising program code:
to perform processing, in an application server, a business intelligence application, the business intelligence application to combine a second OLTP business intelligence value with a second historical business intelligence value to form a correlated report.

15. A computer program product embodied in a non-transitory computer readable medium, the computer readable medium having stored thereon a sequence of instructions which, when executed by a processor causes the processor to execute a method to implement integrated transactional and data warehouse business intelligence analysis, the method comprising:
retrieving a transactional data record from an online transactional processing (OLTP) system, the transactional data record comprising at least one OLTP business intelligence value of a first business intelligence attribute;
receiving, from a storage system, a result set of a query to a data warehouse, the result set comprising a historical business intelligence value of the first business intelligence attribute;
processing, in an application server, a business intelligence application, the business intelligence application to combine the OLTP business intelligence value with the historical business intelligence value to form a correlated report; and
displaying the correlated report on a single surface.

16. The computer program product of claim 15, further comprising:
instructions for reformatting the correlated report to display at least one trend line, the trend line comprising at least one point being the OLTP business intelligence value, and at least one point being the historical business intelligence value.

17. The computer program product of claim 15, further comprising:
instructions for reformatting the correlated report to display on a mobile device.

18. The computer program product of claim 17, further comprising:
instructions for transmitting the reformatted correlated report to the mobile device.

19. The computer program product of claim 15, further comprising:
instructions for caching the result set in a cache; and
instructions for using the cache to access at least one of, the OLTP business intelligence value, and the historical business intelligence value.

20. The computer program product of claim 15, wherein receiving from a storage system comprises receiving from at least one of, a relational database, a cloud, and a storage device.
